(19) United States
(12) Patent Application Publication
(10) Pub. No.: US 2023/0243523 A1
(43) Pub. Date: Aug. 3, 2023

(54) SOUND INSULATION ASSEMBLY, AND AIR CONDITIONER HAVING SAME

(71) Applicants: Qingdao Haier Air Conditioner General Corp., Ltd., Qingdao, Shandong (CN); Haier Smart Home Co., Ltd., Qingdao, Shandong (CN)

(72) Inventors: Jiaxing GUO, Qingdao (CN); Xiangyu LIU, Qingdao (CN)

(73) Assignees: Qingdao Haier Air Conditioner General Corp., Ltd., Qingdao, Shandong (CN); Haier Smart Home Co., Ltd., Qingdao, Shandong (CN)

(21) Appl. No.: 18/002,524

(22) PCT Filed: Dec. 31, 2020
(86) PCT No.: PCT/CN2020/142165

§ 371 Date: Dec. 20, 2022

(30) Foreign Application Priority Data
Jun. 23, 2020 (CN) 202021183357.5

(51) Int. Cl. F24F 1/40

(52) U.S. Cl. CPC F24F 1/40

(57) ABSTRACT

A sound insulation assembly, and an air conditioner having same, to solve the problem of poor sound insulation. The sound insulation assembly of the air conditioner includes a housing and a cover; an accommodation space to accommodate a compressor assembly is formed in the housing; the top of the housing is covered with the cover; a sound insulation chamber is defined by the cover and the accommodation space; the compressor assembly is arranged in the sound insulation chamber; the sound insulation assembly further includes a first sealing component; the first sealing component is arranged on contact areas of the housing and the cover for sealing. The compressor assembly is arranged so that noise generated by operating of the compressor assembly can be better insulated in the sound insulation chamber.

### FIELD

The present disclosure relates to the technical field of air conditioning, and specifically provides a sound insulation assembly and an air conditioner with the sound insulation assembly.

### BACKGROUND

With the improvement of people's living standards, air conditioners are being more and more widely used. However, a compressor assembly of the air conditioner will produce loud noise during operation, resulting in poor user experience. In the current noise reduction method, a noise reduction felt is generally used to wrap the surroundings and a top cover of the compressor assembly. However, the sound leakage is relatively serious and the noise reduction effect is poor. The Chinese patent publication No. CN110748981A discloses a sound insulation assembly. As shown in FIG. 1, the sound insulation assembly 10 is installed on a base 30 and encases an outer surface of a compressor assembly 20; the compressor assembly 20 includes a compressor 21, a liquid reservoir 22 and a four-way valve 23; the four-way valve 23 is arranged above the compressor 21, and is connected with the compressor 21 and the liquid reservoir 22 respectively through a first exhaust pipe 24 and a second exhaust pipe 25. The sound insulation assembly 10 includes a foaming material layer 100, a sound insulation layer 200 and a sound insulation top cover 300. The sound insulation layer 200 and the foaming material layer 100 enclose a sound insulation cavity. A plurality of sound absorption holes 110 are provided in the foaming material layer 100. The compressor 21 and the liquid reservoir 22 are located in the sound insulation cavity. In addition, the sound insulation top cover 300 is provided with a first installation hole and a second installation hole which penetrate through the sound insulation top cover 300 and which are respectively matched with the first exhaust pipe 24 and the second exhaust pipe 25. A first installation slot is provided between the first installation hole and an outer edge of the sound insulation top cover 300, and a second installation slot is provided between the second installation hole and the outer edge of the sound insulation top cover 300, so that the sound insulation top cover 300 is installed above the sound insulation cavity and that the sound insulation cavity can be closed for sound insulation.

However, during the operation of the compressor assembly, it is still possible for the noise generated by the compressor assembly to leak to the outside of the sound insulation assembly from a slit between the above sound insulation cavity and the sound insulation top cover, the first installation slot, the second installation slot and other gaps, resulting in poor sound insulation effect of the sound insulation assembly.

Accordingly, there is a need for a new technical solution in the art to solve the above problem.

### SUMMARY

In order to solve the above problem in the prior art, that is, to solve the problem of poor sound insulation effect of the existing sound insulation assemblies, in an aspect, the present disclosure provides a sound insulation assembly, which includes a housing and a cover; the housing is formed with an accommodation space capable of accommodating a compressor assembly, and the cover covers a top of the housing; the cover and the accommodation space enclose a sound insulation cavity, and the compressor assembly is arranged in the sound insulation cavity; the sound insulation assembly further includes a first sealing member, which is at least arranged in a contact area between the housing and the cover to block a gap of the contact area, so that the housing and the cover are sealedly connected.

In a preferred technical solution of the above sound insulation assembly, the first sealing member is arranged in the contact area between the housing and the cover in a bonding manner

In a preferred technical solution of the above sound insulation assembly, the first sealing member includes a substrate, one side of the substrate is provided with an adhesive layer, and the substrate can at least cover the contact area; in an assembled state, the first sealing member is arranged in the contact area in a removable manner through the adhesive layer, so that the housing and the cover are sealedly connected.

In a preferred technical solution of the above sound insulation assembly, the first sealing member includes a first part and a second part that are matched and connected; the first part is arranged circumferentially at each of the positions of the housing and the cover that correspond to the contact area, and the second part can at least cover the contact area; in an assembled state, the housing is sealedly connected with the cover through the matching of the second part and the first part.

In a preferred technical solution of the above sound insulation assembly, the sound insulation assembly further includes a second sealing member, and at least one installation hole is arranged on the cover; an installation slot is provided between the installation hole and an outer edge of the cover, and a pipeline of the compressor assembly can penetrate into the installation hole via the installation slot; in which the second sealing member is arranged at the installation slot to block the installation slot.

In a preferred technical solution of the above sound insulation assembly, the sound insulation assembly further includes a third sealing member, which is arranged at the installation hole to block a gap between the installation hole and the pipeline.

In a preferred technical solution of the above sound insulation assembly, in a case where the installation hole is provided in plural, a plurality of installation slots are correspondingly provided between the plurality of installation holes and the outer edge of the cover, and at least some of the installation slots extend in opposite directions on the cover.

In a preferred technical solution of the above sound insulation assembly, the housing and/or the cover includes a sound insulation layer and a silencing layer, and the silencing layer is attached to an inner wall of the sound insulation layer.

In a preferred technical solution of the above sound insulation assembly, the sound insulation layer is made of polyvinyl chloride or rubber; and/or the silencing layer is made of polyester fiber materials or acrylonitrile materials.

It can be understood by those skilled in the art that in the new technical solution, the sound insulation assembly includes a housing and a cover, the housing is formed with an accommodation space capable of accommodating the compressor assembly, and the cover covers a top of the housing, so that the cover and the accommodation space in the housing can enclose a sound insulation cavity, and the compressor assembly is arranged in the sound insulation cavity, thus enabling the noise generated during the operation of compressor assembly to be insulated in the sound insulation cavity. The sound insulation assembly of the present disclosure further includes a first sealing member, which is at least arranged in the contact area between the housing and the cover. The gap of the contact area can be blocked by the first sealing member, so that the housing and the cover can be sealedly connected, and therefore the noise generated during the operation of the compressor assembly can be better insulated in the sound insulation cavity.

Further, in a preferred technical solution of the present disclosure, the first sealing member is arranged in the contact area between the housing and the cover in a bonding manner, so that after the housing and the cover are assembled, the first sealing member can be arranged in the contact area between the housing and the cover very conveniently. Preferably, the first sealing member includes a substrate and an adhesive layer provided on one side of the substrate. The substrate can at least cover the contact area between the housing and the cover, so that in the assembled state, the first sealing member is stuck to the contact area through the adhesive layer, and the housing and the cover can be sealedly connected.

Further, in another preferred technical solution of the present disclosure, the first sealing member includes a first part and a second part that are matched and connected; the first part is arranged circumferentially at each of the positions of the housing and the cover that correspond to the contact area, and the second part can at least cover the contact area; in the assembled state, the second part is matched and connected with the first part arranged on the housing and the cover respectively so that the housing and the cover can be sealedly connected.

Further, the sound insulation assembly further includes a second sealing member, and at least one installation hole is arranged on the cover to facilitate an air inflow pipe and an air outflow pipe of the compressor assembly to pass through; an installation slot is provided between the installation hole and the outer edge of the cover to facilitate the installation of the cover on top of the housing after the housing is sleeved over an outer side of the compressor assembly. The second sealing member is arranged at the installation slot, so that the installation slot can be blocked by the second sealing member, and therefore the noise generated during the operation of the compressor assembly can be better insulated in the sound insulation cavity.

Further, the sound insulation assembly also includes a third sealing member, which is arranged at the installation hole; in the assembled state, the third sealing member is arranged at the gaps between the air inflow pipe and the air outflow pipe of the compressor assembly and the installation hole, so that the noise can be better insulated in the sound insulation cavity.

Further, in a case where the installation hole is provided in plural, the installation slot is also correspondingly provided in plural; at least some of the installation slots extend in opposite directions on the cover, so that the installation slots can be scattered on the cover. In this way, when installing the cover, the cover will not be deformed or even damaged due to the overly concentration of the installation slots.

Further, the housing and/or the cover include a sound insulation layer and a silencing layer which is attached to the inner wall of the sound insulation layer. In this way, the sound insulation cavity is composed of the silencing layer and the sound insulation layer from inside to outside, and the noise generated during the operation of the compressor assembly in the sound insulation cavity is first absorbed by the silencing layer, and then blocked by the sound insulation layer, so that a better noise insulation effect can be realized. Preferably, the sound insulation layer is made of polyester fiber materials or acrylonitrile materials, and the silencing layer is made of polyvinyl chloride (PVC) or rubber.

In another aspect, the present disclosure also provides an air conditioner, which is configured with the sound insulation assembly described in any of the above solutions.

It should be noted that the air conditioner has all the technical effects of the sound insulation assembly described above, and a repeated description is omitted herein.

### BRIEF DESCRIPTION OF THE DRAWINGS

The sound insulation assembly of the present disclosure will be described below with reference to the accompanying drawings and in combination with an air conditioner. In the drawings:

FIG. 1 is a partial schematic view of an outdoor unit of an air conditioner in the prior art;

FIG. 2 is a first schematic structural view of a sound insulation assembly of an air conditioner according to an embodiment of the present disclosure;

FIG. 3 is a second schematic structural view of the sound insulation assembly of the air conditioner according to the embodiment of the present disclosure, in which a first installation slot and a second installation slot are shown; and

FIG. 4 is a third schematic structural view of the sound insulation assembly of the air conditioner according to the embodiment of the present disclosure, in which a schematic sectional view of the sound insulation assembly is shown.

### DETAILED DESCRIPTION

Preferred embodiments of the present disclosure will be described below with reference to the drawings. It should be understood by those skilled in the art that these embodiments are only used to explain the technical principles of the present disclosure, and are not intended to limit the scope of protection of the present disclosure.

It should be noted that in the description of the present disclosure, directional or positional relationships indicated by terms such as “central”, “upper”, “lower”, “left”, “right”, “vertical”, “horizontal”, “inner” and “outer” are based on the directional or positional relationships shown in the drawings. They are merely used for the convenience of description, and do not indicate or imply that the device or element involved must have a specific orientation, or be configured or operated in a specific orientation, and therefore they should not be construed as limiting the present disclosure. In addition, terms “first” and “second” are used for descriptive purpose only, and should not be construed as indicating or implying relative importance.

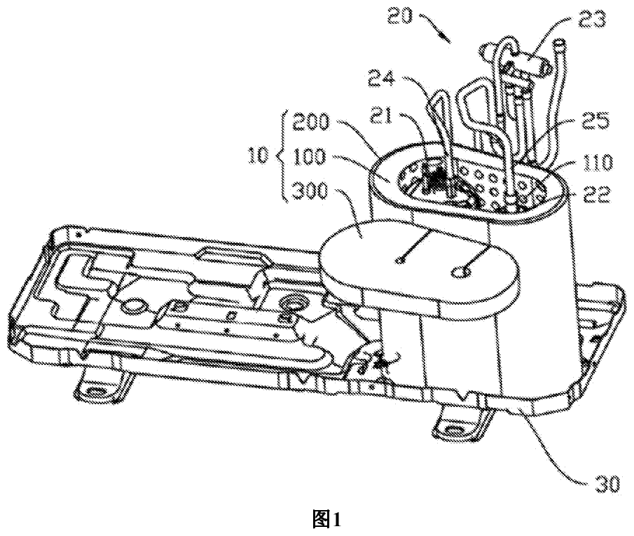

Reference is made to FIG. 1, which is a partial schematic view of an outdoor unit of an air conditioner in the prior art. As shown in FIG. 1, the air conditioner includes an outdoor unit of the air conditioner and an indoor unit of the air conditioner. The outdoor unit of the air conditioner includes a base 30 and a compressor assembly 20 arranged on the base 30. The compressor assembly 20 compresses and drives a refrigerant to circulate between the indoor unit and the outdoor unit, so as to achieve the purpose of adjusting air quality of an indoor space. In order to reduce the noise generated during the operation of the compressor assembly 20, a sound insulation assembly 10 is usually arranged outside the compressor assembly 20. The sound insulation assembly 10 includes a sound insulation cavity enclosed by a sound insulation layer 200 and a foaming material layer 100, and a sound insulation top cover 300 arranged above the sound insulation cavity. The sound insulation top cover 300 is provided with a first installation hole and a second installation hole therethrough, which are respectively matched with a first exhaust pipe 24 and a second exhaust pipe 25. A first installation slot is arranged between the first installation hole and an outer edge of the sound insulation top cover 300, and a second installation slot is arranged between the second installation hole and the outer edge of the sound insulation top cover 300, so as to insulate the noise generated during the operation of the compressor assembly 20 in the sound insulation assembly 10. However, as described in the “BACKGROUND OF THE INVENTION”, even if the sound insulation assembly 10 shown in FIG. 1 is arranged outside the compressor assembly 20, the noise can still leak to the outside of the sound insulation assembly 10 from a slit between the sound insulation cavity and the sound insulation top cover 300, the first installation slot, the second installation slot, a gap between the first installation hole and the first exhaust pipe 24, a gap between the second installation hole and the second exhaust pipe 25, etc., which leads to poor sound insulation effect of the sound insulation assembly 10.

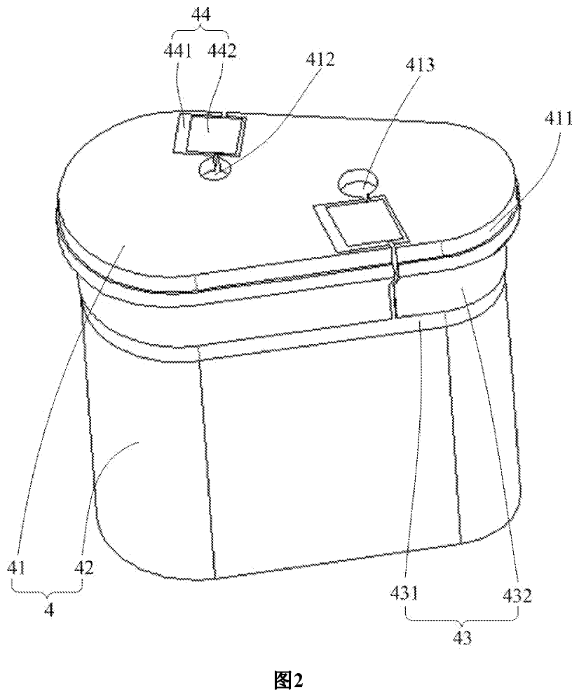

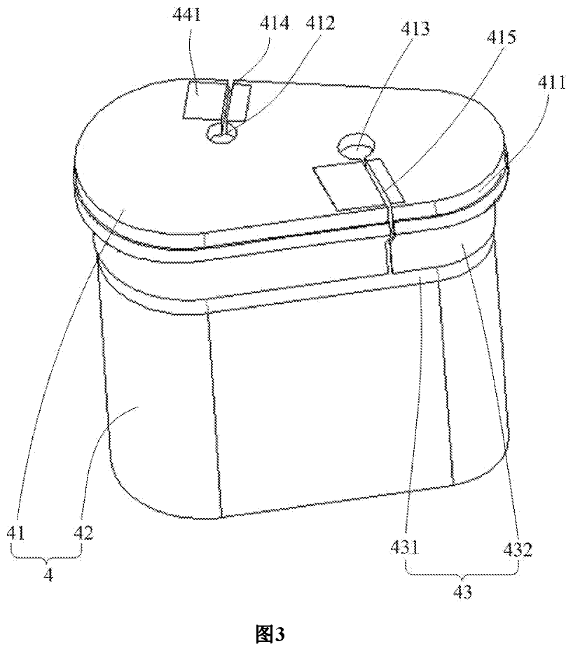

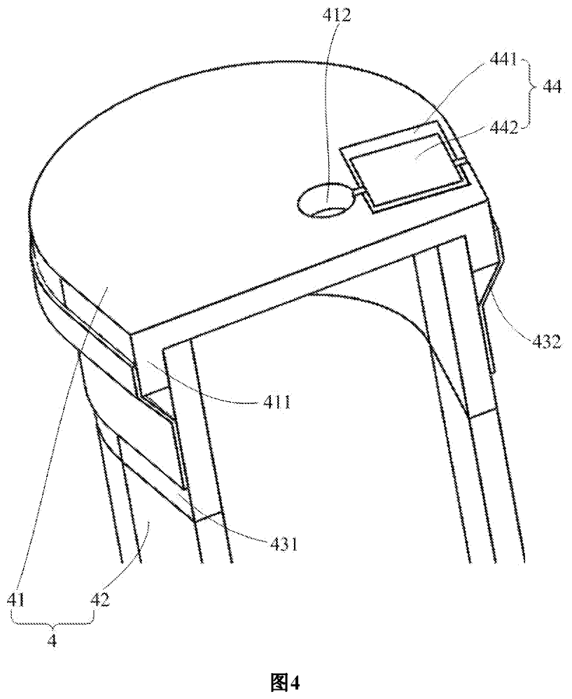

Reference is made to FIGS. 2 to 4, in which FIG. 2 is a first schematic structural view of a sound insulation assembly of an air conditioner according to an embodiment of the present disclosure, FIG. 3 is a second schematic structural view of the sound insulation assembly of the air conditioner according to the embodiment of the present disclosure, and FIG. 4 is a third schematic structural view of the sound insulation assembly of the air conditioner according to the embodiment of the present disclosure. In order to further reduce the noise generated during the operation of the compressor assembly, as shown in FIGS. 2 to 4, the sound insulation assembly 4 of the present disclosure includes a housing 42, a cover 41 and a first sealing member 43. The housing 42 is roughly of a cylindrical structure with a large cross section at one end and a small cross section at the other end. The cylindrical structure has an accommodation space that can just accommodate the compressor assembly. The cover 41 is arranged at a top of the housing 42, that is, the cover 41 covers the accommodation space from above. In this way, a sound insulation cavity can be formed. In a case where the sound insulation assembly 4 is sleeved in the compressor assembly, the compressor assembly is located in the sound insulation cavity. In this way, the noise generated during the operation of the compressor assembly can be insulated in the sound insulation cavity, thus effectively reducing the noise generated during the operation of the outdoor unit of the air conditioner. Further, a first sealing member 43 is provided in a contact area between the housing 42 and the cover 41. The first sealing member 43 can block a gap at the contact area, which is located above the housing 42 and below the cover 41, so that the housing 42 and the cover 41 can be sealedly connected, and therefore the noise generated during the operation of the compressor assembly can be better insulated in the sound insulation cavity.

In this embodiment, the first sealing member can be arranged in the contact area between the housing and the cover in a variety of ways. For example, the first sealing member is arranged in the contact area in a circumferential direction of the housing and the cover, and an annular hoop is provided on an outer side of the first sealing member, so that the first sealing member is arranged in the contact area by fastening the hoop. For another example, inner walls of the housing and the cover are provided with iron sheets at positions corresponding to the contact area, and the first sealing member is correspondingly provided with a magnet, so that the first sealing member can be arranged in the contact area by means of magnetic adsorption. For further another example, the first sealing member is arranged in the contact area in a bonding manner, etc. Those skilled in the art can flexibly choose the way of arranging the first sealing member in the contact area according to specific application scenes, so as to adapt to more specific applications. In the following, possible implementations of the present disclosure will be described in connection with the drawings in an example in which the first sealing member is arranged in the contact area in a bonding manner

In one possible embodiment, the first sealing member includes a substrate and an adhesive layer, and the adhesive layer is arranged on the substrate. Specifically, the substrate is of a sheet structure, having a length which is substantially the same as a circumferential length of the cover, and a width that can cover the contact area between the housing and the cover. The adhesive layer is arranged on the sheet structure by coating, that is, the adhesive layer is arranged on the sheet structure in an irremovable manner For example, the first sealing member is a sealing tape, or a sealing cotton, a sound insulation cotton, a felt and the like with a glue layer. In an assembled state, the first sealing member can be stuck to the contact area between the housing and the cover through the adhesive layer, thus blocking the gap of the contact area, so that the housing and the cover can be sealedly connected. When the housing and the cover need to be separated, the first sealing member can be peeled off. Obviously, the adhesive layer can also be arranged on the substrate in other ways. For example, it can be attached to the substrate in a removable way. Those skilled in the art can flexibly choose the way of arranging the adhesive layer on the substrate according to specific application scenes.

In another possible embodiment, as shown in FIGS. 2 to 4, the first sealing member 43 includes a first part 431 and a second part 432, and the first part 431 is matched and connected with the second part 432. For example, the first sealing member 43 is a Velcro, and the first part 431 and the second part 432 can be regarded as a hair surface and a thorn surface of the Velcro, etc. The cover 41 includes a body and a flange 411. The body is substantially of a horizontally arranged structure with a large end and another small end, which is adapted to the cylindrical structure. The flange 411 extends downward along the circumference of the body. The first part 431 is arranged in an upper area of the housing 42 and on the flange 411 respectively. When the cover 41 is assembled with respect to the housing 42, the second part 432 is matched with the first part 431, and the second part 432 can cover an intersection position between the top of the housing 42 and the flange 411, so that the first sealing member 43 can seal the gap of the contact area, thus realizing the sealed connection between the housing 42 and the cover 41.

It can be understood that the first part and the second part can also be matched and connected in other ways. For example, the first part and the second part are both provided with an adhesive layer, and the first part and the second part are connected with each other through the adhesive layers. Those skilled in the art can flexibly choose the specific form of matching and connecting the first part with the second part according to specific application scenes, so as to adapt to more specific applications.

With continued reference to FIGS. 2 to 4, in a possible embodiment, an upper surface of the cover 41 is provided with at least one installation hole, which is matched with a pipeline of the compressor assembly. An installation slot is provided between the installation hole and an outer edge of the cover, and the pipeline passes into the installation hole via the installation slot and is positioned by the installation hole, so that the cover can be conveniently installed above the housing. A second sealing member is arranged at the installation slot, and the installation slot can be blocked by the second sealing member, so that the noise generated during the operation of the compressor assembly can be better insulated in the sound insulation cavity.

It should be noted that the models of compressor assemblies configured for different models of air conditioners are also different, and the number of installation holes required to be provided on the cover is also different for different models of compressor assemblies. In the following, possible embodiments of the present disclosure will be described with reference to the drawings in an example in which two installation holes are provided on the cover.

As shown in FIGS. 2 to 4 and in accordance with the orientation shown in FIG. 2, the cover 41 is provided with a first installation hole 412 on the left side and a second installation hole 413 on the right side. A first installation slot 414 is provided between the first installation hole 412 and an upper edge of the cover 41, and a second installation slot 415 is provided between the second installation hole 413 and a lower edge of the cover 41. The pipeline of the compressor assembly includes a first exhaust pipe and a second exhaust pipe, so that when installing the cover 41 above the housing 42, firstly, the first exhaust pipe can pass through the first installation slot 414 and can be positioned by the first installation hole 412, and then the second exhaust pipe can pass through the second installation slot 415 and can be positioned by the second installation hole 413. It can be seen that the first installation slot 414 and the second installation slot 415 are respectively arranged at the upper and lower edges of the cover 41, that is, the two installation slots extend in opposite directions, so that when installing the cover 41, the cover 41 will not be deformed or even damaged due to overly concentration of stress caused by the arrangement of the first installation slot 414 and the second installation slot 415 on the same side of the cover 41.

It should be noted that the first sealing member 43 and the second sealing member 44 may be the same or different. For example, the first sealing member 43 is of a sheet structure provided with an adhesive layer, and the second sealing member 44 is a Velcro composed of a hair surface and a thorn surface. For another example, the first sealing member 43 and the second sealing member 44 are both Velcros composed of a hair surface and a thorn surface, etc. Those skilled in the art can flexibly choose the specific arrangement of the first sealing member 43 and the second sealing member 44 according to the specific application scenes, as long as the slit of the contact area can be blocked by the first sealing member 43, and the first installation slot 414 and the second installation slot 415 can be blocked by the second sealing members 44. In the following, possible implementations of the present disclosure will be described with reference to the drawings in an example in which the second sealing member 44 is a Velcro.

Taking the first installation slot 414 as an example, the second sealing member 44 includes a third part 441 and a fourth part 442 that are matched and connected. The third part 441 is arranged at positions of the cover 41 that correspond to the left and right sides of the first installation slot 414, respectively. After the cover 41 is installed at the top of the housing 42, the fourth part 442 is matched with the third part 441 on the left and right sides of the first installation slot 414, respectively. In this way, the second sealing member 44 is arranged above the first installation slot 414, so that the part of the first installation slot 414 on the upper surface of the cover 41 can be blocked, and therefore the noise can be better insulated in the sound insulation cavity. Obviously, a length of the second sealing member 44 can also cover the entire first installation slot 414. Obviously, it is possible that the third part 441 is a hair surface, and the fourth part 442 is a thorn surface, or that the third part 441 is the thorn surface, and the fourth part 442 is the hair surface.

It can be understood that the second sealing member 44 can also be arranged in the first installation slot 414 and/or the second installation slot 415. For example, the second sealing member 44 is a silencing cotton, and the silencing cotton of an appropriate size is inserted in the first installation slot 414 and/or the second installation slot 415, etc. Those skilled in the art can flexibly choose the arrangement of the second sealing member in the installation slot according to the specific application scenes, so as to adapt to more specific applications.

It should be noted that after the first exhaust pipe is positioned in the first installation hole 412 and the second exhaust pipe is positioned in the second installation hole 413, there will also be slits existing between the first exhaust pipe and the first installation hole 412, as well as between the second exhaust pipe and the second installation hole 413. Obviously, third sealing members can also be arranged at these slits to block the slits, so as to obtain a sound insulation cavity with better sealing performance, which is capable of better insulating the noise in the sound insulation cavity. For example, the third sealing members may be silencing cottons or silencing felts stuck onto inner walls of the first installation hole 412 and the second installation hole 413. In the assembled state, the first exhaust pipe and the second exhaust pipe respectively compress the corresponding silencing cottons or silencing felts to achieve sealing and sound insulation. Of course, those skilled in the art can flexibly choose the specific arrangement of the third sealing members according to the specific application scenes, as long as the slits between the first exhaust pipe and the first installation hole 412 as well as between the second exhaust pipe and the second installation hole 413 can be blocked.

In a possible embodiment, the housing 42 and the cover 41 both include a sound insulation layer and a silencing layer. The sound insulation layer surrounds and adheres to an outer wall of the silencing layer. In this way, the noise generated during the operation of the compressor assembly in the sound insulation cavity is first absorbed by the silencing layer, and then blocked by the sound insulation layer, so that the noise is minimized and thus a better noise reduction effect is realized. In addition, the slit in the contact area between the housing 42 and the cover 41 and the gaps at the first installation slot 414 and the second installation slot 415 are blocked through the arrangement of the first sealing member 43, the second sealing member 44 and the third sealing members, so that the noise can be better insulated in the sound insulation cavity.

It can be understood that it is also possible that only the housing includes the sound insulation layer and the silencing layer, or only the cover includes the sound insulation layer and the silencing layer. Those skilled in the art can flexibly choose the arrangement of the housing and the cover according to the specific application scenes, so as to adapt to more specific applications.

In a possible embodiment, the silencing layer is made of porous materials such as silencing cotton, fiber, acrylonitrile, etc. The noise collides and rubs in the porous structure, so that the noise is weakened. The sound insulation layer is made of high-density materials that are difficult for the noise to penetrate, such as polyvinyl chloride (PVC) or rubber. Such a sound insulation layer can not only block transmission of the noise from the sound insulation cavity to the outside, but also can support the silencing layer. Specifically, the silencing layer can be attached to the inner wall of the sound insulation layer, and the silencing layer is supported by the sound insulation layer, so that the silencing layer and the sound insulation layer can form a stable integrated structure, and that the housing and the cover can be prepared. During installation, the housing can be directly sleeved over the outside of the compressor assembly, and then the cover can be placed on top of the compressor assembly, which makes the installation convenient.

To sum up, in the preferred technical solutions of the present disclosure, by arranging the compressor assembly in the sound insulation cavity formed by the housing and the cover, and blocking the gaps at different positions on the housing and the cover through a plurality of sealing members, the noise generated during the operation of the compressor assembly can be better insulated in the sound insulation cavity, thus further improving the sound insulation effect of the sound insulation assembly.

Hitherto, the technical solutions of the present disclosure have been described in conjunction with the preferred embodiments shown in the accompanying drawings, but it is easily understood by those skilled in the art that the scope of protection of the present disclosure is obviously not limited to these specific embodiments. Without departing from the principles of the present disclosure, those skilled in the art can make equivalent changes or replacements to relevant technical features, and all the technical solutions after these changes or replacements will fall within the scope of protection of the present disclosure.

1-10. (canceled)

11. A sound insulation assembly, comprising: a housing and a cover, the housing is formed with an accommodation space capable of accommodating a compressor assembly, and the cover covers a top of the housing; the cover and the accommodation space enclose a sound insulation cavity, and the compressor assembly is arranged in the sound insulation cavity; and
a first sealing member, at least arranged in a contact area between the housing and the cover to block a gap of the contact area, so that the housing and the cover are sealedly connected.

12. The sound insulation assembly according to claim 11, wherein the first sealing member is arranged in the contact area between the housing and the cover in a bonding manner

13. The sound insulation assembly according to claim 12, wherein the first sealing member comprises a substrate, one side of the substrate is provided with an adhesive layer, and the substrate can at least cover the contact area; and
in an assembled state, the first sealing member is arranged in the contact area in a removable manner through the adhesive layer, so that the housing and the cover are sealedly connected.

14. The sound insulation assembly according to claim 12, wherein the first sealing member comprises a first part and a second part that are matched and connected, the first part is arranged circumferentially at each of the positions of the housing and the cover that correspond to the contact area, and the second part can at least cover the contact area; and
in an assembled state, the housing is sealedly connected with the cover through the matching of the second part and the first part.

15. The sound insulation assembly according to claim 11, further comprising a second sealing member, wherein at least one installation hole is arranged on the cover, an installation slot is provided between the installation hole and an outer edge of the cover, and a pipeline of the compressor assembly can penetrate into the installation hole via the installation slot; and
the second sealing member is arranged at the installation slot to block the installation slot.

16. The sound insulation assembly according to claim 15, further comprising a third sealing member, wherein the third sealing member is arranged at the installation hole to block a gap between the installation hole and the pipeline.

17. The sound insulation assembly according to claim 15, wherein in a case where the installation hole is provided in plural, a plurality of installation slots is correspondingly provided between the plurality of installation holes and the outer edge of the cover; and
at least some of the installation slots extend in opposite directions on the cover.

18. The sound insulation assembly according to claim 11, wherein the housing and/or the cover comprises a sound insulation layer and a silencing layer, and the silencing layer is attached to an inner wall of the sound insulation layer.

19. The sound insulation assembly according to claim 18, wherein the sound insulation layer is made of polyvinyl chloride or rubber; and/or the silencing layer is made of polyester fiber materials or acrylonitrile materials.

20. An air conditioner, wherein the air conditioner is configured with the sound insulation assembly according to claim 11.
